(19) United States
(12) Patent Application Publication
(10) Pub. No.: US 2024/0079157 A1
(43) Pub. Date: Mar. 7, 2024

(54) METHOD FOR STRIPPING URANIUM(VI) AND AN ACTINIDE(IV) FROM AN ORGANIC SOLUTION BY OXALIC PRECIPITATION

(71) Applicants: COMMISSARIAT A L'ENERGIE ATOMIQUE ET AUX ENERGIES ALTERNATIVES, Paris (FR); CENTRE NATIONAL DE LA RECHERCHE SCIENTIFIQUE, Paris Cedex 16 (FR); Université de Montpellier, Montpellier (FR); École nationale supérieure de chimie de Montpellier, Montpellier (FR)

(72) Inventors: Daniel Meyer, Saint-Genies-De-Comolas (FR); Muriel Bertrand, Saint-Siffret (FR); Damien Bourgeois, Aramon (FR); Julie Durain, Pont-Saint-Esprit (FR)

(21) Appl. No.: 18/458,241

(22) Filed: Aug. 30, 2023

(30) Foreign Application Priority Data
Sep. 2, 2022 (FR) 2208845

(51) Int. Cl. G21F 9/12

(52) U.S. Cl. CPC G21F 9/125

(57) ABSTRACT

A method for stripping U(VI) and an An(IV) from an organic solution including tri-n-butyl phosphate in an organic diluent, the solution containing U(VI) and the An(IV) present as U(VI) nitrate and An(IV) nitrate at concentrations such that the U(VI) nitrate concentration is higher than the An(IV) nitrate concentration, and the sum of the U(VI) nitrate and An(IV) nitrate concentrations is ≥55 g/L. The method includes contacting the organic solution and an aqueous solution of nitric and oxalic acids, the oxalic acid concentration in the aqueous solution and the O/A volume ratio selected so that the oxalic acid is deficient with respect to the stoichiometric conditions of a complete precipitation of U(VI) and actinide(IV), to obtain a precipitate containing the actinide(IV) in oxalate form and a fraction of the U(VI) in oxalate form with a U(VI)/actinide(IV) mass ratio of between 0.5 and 5; and separating the precipitate from the organic and aqueous solutions.

### CROSS-REFERENCE TO RELATED APPLICATIONS

This application claims priority from French Patent Application No. 2208845 filed on Sep. 2, 2022. The content of this application is incorporated herein by reference in its entirety.

### TECHNICAL FIELD

The invention relates to the field of the processing of spent nuclear fuels.

More specifically, it relates to a method for stripping, from an organic solution comprising uranium(VI) and an actinide(IV), all or almost all of the actinide(IV), conjointly with a fraction of the uranium(VI), in a controlled U(VI)/actinide(IV) ratio, by oxalic precipitation.

It also relates to a method for processing an aqueous solution resulting from dissolving a spent nuclear fuel in nitric acid, in which the stripping method is implemented.

### PRIOR ART

At the present time, the operation of the reactors in the French electronuclear installations is based on the use of a fuel composed of natural uranium oxide, enriched with isotope 235, and in some cases a fuel composed of a mixed uranium and plutonium oxide, referred to as MOX fuel (from “Mixed OXide fuel»).

MOX fuel enables the plutonium coming from the processing of spent nuclear fuels to be recycled.

Spent nuclear fuels are currently processed by the PUREX method, which consists schematically of:
dissolving the fuels in nitric acid to put the elements that it contains in solution (uranium, plutonium, minor actinides, fission products, corrosion products);
separating, by liquid-liquid extraction, the reprocessable elements, i.e. uranium(VI) and plutonium(IV), from the other elements which are in their case intended to constitute final waste;
partitioning the uranium(VI) and the plutonium(IV) into two aqueous streams, one of which contains only uranium while the other contains only plutonium;
purifying separately the uranium(VI) and the plutonium(IV) after partitioning thereof, also by liquid-liquid extraction; and
converting the purified plutonium(IV) into a plutonium oxide powder, PuO₂, by oxalic precipitation followed by calcination of the precipitate thus obtained.

Manufacturing MOX fuel uses the MIMAX method, which consists schematically in:
grinding together two powders, respectively uranium oxide, UO₂, and PuO₂, to obtain a micronised homogeneous mixture of these powders;
sieving and then diluting the mixture thus obtained with a UO₂ powder to adjust the plutonium content of the mixture to that required for the fuel;
pressing the mixture in the form of pellets and sintering the pellets at high temperature; and
rectifying the pellets to adjust their dimensions to the specifications.

All the operations of the PUREX and MIMAS methods are described in detail in the monograph of the Nuclear Energy Directorate of the CEA entitled “Treatment and recycling of spent nuclear fuel—Actinide partitioning—Application to waste management”, published in 2008 (Editions Le Moniteur, ISBN 978-2-281-11377-8), hereinafter reference [1].

An important development of the PUREX method, called the COEX™ method, was proposed in the International patent application PCT WO-A-2007/135178, hereinafter reference [2].

This is because, while ensuring recovery and purification of uranium and plutonium comparable to those obtained in the PUREX method, the COEX™ method makes it possible, after dissolving and separation steps similar to those of the PUREX method, to implement a partitioning of the uranium(VI) and of the plutonium(IV) such that it leads to obtaining a first aqueous stream that comprises a mixture of uranium and plutonium, and a second aqueous stream that comprises only uranium. Once the uranium and plutonium of the first aqueous stream have been purified by liquid-liquid extraction, this stream supplies a so-called “co-conversion” workshop, the function of which is to prepare, by oxalic co-precipitation of the uranium and plutonium and calcination of the precipitate obtained, a powder of a mixed (U,Pu)O₂ oxide that can be directly used for manufacturing a MOX fuel.

Whether in the PUREX method or in the COEX™ method, the oxalic (co)precipitation is implemented in an aqueous solution with, in the case of the COEX™ method, a prior reduction of the uranium(VI) and of the plutonium(IV), respectively into the IV oxidation state and into the III oxidation state.

With a view to developing new factories for processing-recycling spent nuclear fuels, it would be desirable to have a method for best reducing the number of operations that have to be implemented between the dissolution of the fuels in nitric acid and the obtention of a powder of a mixed (U,Pu)O₂ oxide that can be directly used for manufacturing a MOX fuel.

Stripping metal elements from an organic solution while precipitating these elements by putting the organic solution in contact with an aqueous solution comprising a precipitating agent is known. This type of stripping is called “stripping by precipitation” or “precipitating stripping” (or “precipitation-stripping”).

In particular, stripping plutonium(IV), alone or in a mixture with uranium(VI) or americium(III), from an organic solution by oxalic precipitation is known.

Thus a method has been described, in the British patent GB B-834,531, hereinafter reference [3], which consists in putting an organic phase comprising 20% (v/v) tri-n-butyl phosphate (or TBP, which is the extractant used in the PUREX and COEX™ methods) in kerosene, with plutonium(IV) previously added to the extent of 2 g/L, in contact with an aqueous phase comprising from 1.5 mol/L to 3 mol/L of nitric acid and 0.25 mol/L of oxalic acid, in an organic/aqueous (or O/A) volume ratio of 4. After 30 minutes of stirring, the aqueous phase containing the plutonium oxalate is drawn off and subjected to a filtration to recover this oxalate. In parallel, the organic phase is washed with water, in an O/A ratio of 4, to eliminate from this phase the plutonium oxalate liable to be dissolved or in suspension in said phase and to combine it, after filtration, with the plutonium oxalate previously recovered. According to the authors of this reference, the plutonium(IV) would precipitate at 99.4%.

More recently, in the European patent application EP-A-0 251 399, hereinafter reference [4], a method for recovery plutonium(IV) by oxalic precipitation from an organic phase comprising TBP at 15%, 20% or 30% (v/v) in n-dodecane and in which the plutonium is present alone or conjointly with uranium(VI) or americium(III) was described. In this method, the organic phase is first of all diluted to bring the plutonium concentration below 10 g/L and, in the case where the organic phase also comprises uranium, to bring the total plutonium and uranium concentration below 45 g/L, and then the organic phase is put in contact with an aqueous solution comprising 1 mol/L of nitric acid and 0.5 mol/L of oxalic acid. According to the authors of this reference, the precipitation of the plutonium(IV) in oxalate form would be quantitative or almost quantitative. When uranium is present in the organic phase, a greater or lesser quantity of uranium oxalate is also found in the precipitate.

It happens that, in the context of their work, the inventors found that, contrary to the teaching of reference [4], which emphasises the need to previously dilute the organic phase to bring the total plutonium and uranium content below 45 g/L if it is wished to obtain an effective precipitation of the plutonium, it is entirely possible to very satisfactorily precipitate an actinide(IV), such as plutonium or thorium, with a selected fraction of uranium when the actinide(IV) and uranium are present in an organic phase with a total actinide(IV) and uranium(VI) content greater than 45 g/L, without proceeding with any previous dilution of this organic phase, provided that the concentrations of nitric acid and oxalic acid in the aqueous solution are chosen appropriately.

They also found that, if the concentrations of nitric acid and oxalic acid in the aqueous solution are not suitably chosen, then an impurity consisting of uranium, oxalate and TBP forms in the precipitate, which makes the use of this precipitate for preparing a mixed oxide (U,Pu)O₂ intended for manufacturing a MOX fuel prohibitive. This is in no way mentioned in reference [4].

They furthermore found that, by suitably choosing the concentrations of nitric acid and oxalic acid, it is possible to obtain a precipitation of all or almost all of the actinide(IV), conjointly with a fraction of the uranium(VI), in a perfectly controlled U(VI)/Pu(IV) mass ratio, which, there also, is in no way mentioned in reference [4].

And it is on these experimental findings that the invention is based.

### DISCLOSURE OF THE INVENTION

The object of the invention is therefore a method for stripping uranium(VI) and an actinide(IV) from an organic solution in which the uranium(VI) and actinide(IV) are present in the form of nitrates at concentrations such that the concentration of uranium(VI) nitrate is higher than the concentration of actinide(IV) nitrate, and the sum of the concentrations of the uranium(VI) nitrate and actinide(IV) nitrate is greater than or equal to 55 g/L, the organic solution comprising TBP in an organic diluent, said method comprising:
at least one contact between the organic solution and an aqueous solution comprising from 2 mol/L to 6 mol/L of nitric acid, and oxalic acid at a concentration greater than or equal to 18 g/L, with an O/A ratio greater than or equal to 1, the concentration of the oxalic acid in the aqueous solution and the O/A ratio being selected so that the oxalic acid is deficient with respect to the stoichiometric conditions of a complete precipitation of uranium(VI) and actinide(IV), whereby a precipitate is obtained which comprises the actinide(IV) in oxalate form and a fraction of uranium(VI) in oxalate form with a U(VI)/actinide(IV) mass ratio of between 0.5 and 5; then
a separation of the precipitate from the organic and aqueous solutions.

Hereinabove and hereinafter, the terms “aqueous solution” and “aqueous phase” are equivalent and interchangeable, just like the terms “organic solution” and “organic phase”.

Moreover, “organic diluent” means any non-polar hydrocarbon or mixture of non-polar hydrocarbons, aliphatic and/or aromatic, the use of which has been proposed for dissolving TBP. By way of examples of such a diluent, mention can in particular be made of n-dodecane, hydrogenated tetrapropylene (or TPH), kerosene and isoparaffinic diluents such as those sold by TotalEnergies under the references Isane™ IP-185 and Isane™ IP-175.

In accordance with the invention, the sum of the concentrations of the uranium(VI) nitrate and actinide(IV) nitrate in the organic solution is preferably greater than or equal to 70 g/L.

Moreover, this organic solution preferably comprises from 25% to 35% (v/v) and more preferentially 30% (v/v) of tri-n-butyl phosphate.

The aqueous solution, for its part, preferably has an oxalic acid concentration greater than or equal to 20 g/L and, better still, greater than or equal to 22 g/L.

As for the O/A ratio, it is preferably greater than or equal to 1.5.

In accordance with the invention, it is preferred for the precipitate comprising the actinide(IV) in oxalate form and the fraction of uranium(VI) in oxalate form to have a U(VI)/actinide(IV) mass ratio between 1 and 3 and, preferably, equal to 1.

To do this, the aqueous solution preferentially has an oxalic acid molar concentration 5 times to 10 times higher than the molar concentration of the actinide(IV), on the understanding that a person skilled in the art, seeking to obtain a precipitate having a given U(VI)/actinide(IV) mass ratio, will be perfectly able to adjust, depending on the other operating parameters (nitric acid concentration in particular), the oxalic acid molar concentration that has to be used to achieve this mass ratio.

In accordance with the invention, the separation of the precipitate from the organic and aqueous solutions can be implemented in a single step by filtration. By way of non-limitative example, the filtration can be done continuously using a drum filter, or discontinuously using a filter press. The recovered filtrate consists of a mixture of residual aqueous and organic phases that can then be separated and processed independently in accordance with the conventional techniques used in the methods for separation by liquid-liquid extraction.

Advantageously, the method further comprises, once the precipitate has been separated from the organic and aqueous solutions, one or more washings of this precipitate that are implemented either with an aqueous solution comprising nitric acid or with an organic solution comprising the diluent, each washing being followed by a separation of the precipitate from the washing aqueous or organic solution. Preferably, a single washing is implemented with an aqueous solution of nitric acid.

The actinide(IV) may be plutonium(IV) or thorium(IV), preference being given to plutonium(IV).

The stripping method that has just been described finds a particular interest for processing an organic solution comprising a mixture composed of 75% to 95% by mass uranium(VI) and 5% to 25% by mass an actinide(IV) and, in particular, plutonium(IV).

It can advantageously be used to simplify the processing of an aqueous solution issued from the dissolution of a spent nuclear fuel in nitric acid.

Thus, another object of the invention is a method for processing an aqueous solution issued from the dissolution of a spent nuclear fuel in nitric acid, the aqueous solution comprising at least uranium(VI) and an actinide(IV), the method comprising at least the steps of:
co-extracting the uranium(VI) and actinide(IV) from the aqueous solution, the co-extracting comprising at least one contact between the aqueous solution and an organic solution comprising tri-n-butyl phosphate in an organic diluent, and then a separation of the aqueous solution from the organic solution;
b) stripping the actinide(IV) and a fraction of the uranium(VI) of the organic solution issued from step a), the stripping comprising an implementation of the stripping method as previously described; and
c) stripping from the organic solution the uranium(VI) that was not stripped in step b) from the organic solution, the stripping comprising at least one contact between the organic solution issued from step b) and an aqueous solution comprising from 0.005 mol/L to 0.05 mol/L of nitric acid, and then a separation of the organic solution from the aqueous solution.

This processing method may also comprise, between steps a) and b), a washing of the organic solution issued from step a), the washing comprising at least one contact between the organic solution issued from step a) and an aqueous solution comprising 0.5 mol/L to 6 mol/L, preferably 4 mol/L to 6 mol/L, of nitric acid, and then a separation of the organic solution from the aqueous solution.

Equally, it may also comprise a regeneration of the organic solution issued from step c) with a view to re-use thereof in step a), this regeneration preferably comprising at least one washing of the organic solution issued from step c) with a basic aqueous solution, followed by at least one washing of the organic solution with an aqueous solution of nitric acid.

Furthermore, it may also comprise a conversion of the precipitate issued from step b) into a mixed uranium(VI) and actinide(IV) oxide, this conversion preferably comprising a calcination of the precipitate at a temperature ranging from 600° C. to 800° C. under an oxidising atmosphere, typically air.

In the context of the processing method described above, the actinide(IV) may be plutonium(IV) or thorium(IV), preferably plutonium(IV).

Other features and advantages of the invention will become apparent from the following additional description, which refers to the accompanying figures.

It goes without saying however that this additional description is provided solely for the purpose of illustrating the object of the invention and must not be interpreted as constituting a limitation thereof.

### BRIEF DESCRIPTION OF THE FIGURES

FIG. 1 illustrates the powder X-ray diffractograms of the solids obtained by stripping uranium(VI) from an organic solution comprising 1 mol/L of TBP in n-dodecane by means of an aqueous solution comprising 0.20 mol/L of oxalic acid and 0 mol/L to 2 mol/L of nitric acid; by way of reference, this figure also shows the powder X-ray diffractogram of uranyl oxalate trihydrate, UO₂ (C₂O₄)₂·3H₂O.

FIG. 2 illustrates the powder X-ray diffractogram, denoted 1, of the solid obtained by stripping uranium(VI) and thorium(IV) from an organic solution comprising 1 mol/L of TBP in n-dodecane by means of an aqueous solution comprising 0.24 mol/L of oxalic acid and 2 mol/L of nitric acid; by way of reference, this figure also shows the powder X-ray diffractograms of uranyl oxalate trihydrate, UO₂ (C₂O₄)₂·3H₂O, and of thorium oxalate hexa hydrate, Th(C₂O₄)₂·6H₂O.

FIG. 3 illustrates an outline diagram of an embodiment of the method for processing an aqueous solution resulting from a dissolution of a spent nuclear fuel in nitric acid according to the invention; on this figure, the rectangles denoted 1, 2 and 5 represent multistage extractors such as those conventionally used in processing spent nuclear fuels (mixer-settlers, pulsed columns or centrifugal extractors); in addition, the organic phases are represented by a single solid line; the aqueous phases are represented by a single broken line while the solid phases are represented by a double solid line.

### DETAILED DISCLOSURE OF PARTICULAR MODES OF IMPLEMENTATION

I—Experimental Validation of the Stripping Method of the Invention:

The oxalic-precipitation stripping tests that are reported below are implemented using:
as organic solutions; solutions comprising either uranyl nitrate (test 1) or a mixture of uranyl nitrate and thorium nitrate (test 2) in a solvent composed of TBP (97% pure), at a concentration of 1 mol/L, in n-dodecane (more than 99% pure); and
as aqueous solutions: solutions comprising oxalic acid and nitric acid in water.

For preparing the organic solutions, crystals of uranyl nitrate hexahydrate, UO₂(NO₃)₂·6H₂O, and, in the case of test 2, thorium nitrate pentahydrate, Th(NO₃)₄·5H₂O, are dissolved in 6M nitric acid. Then the actinide nitrate(s) is (are) extracted from the aqueous solution thus obtained by means of the 1M TBP/n-dodecane solvent. To do this, this aqueous solution is put in contact in a 5 mL tube with the pre-balanced solvent at ambient temperature (21° C.±2° C.), with an O/A ratio of 1; the tube is placed in a thermostatically controlled orbital shaker at 20° C., at a speed of 1000 rpm, for 10 minutes. After settling by gravity, the aqueous and organic phases are separated from each other by taking off the organic phase.

For preparing the aqueous solutions comprising oxalic acid and nitric acid, an oxalic acid dihydrate powder, C₂O₄H₂O·2H₂O, 99.5% pure, is dissolved in an aqueous solution of HNO₃.

For each precipitation test, 250 μL of an organic solution is added, dropwise, to 250 μL of an aqueous solution in a 4 mL glass pill organiser under magnetic stirring of 500 rpm, and then the pill organiser is placed in a thermostatically controlled orbital shaker at 21° C., at a speed of 1000 rpm, for 1 hour.

After which the content of the pill organiser is sucked out and decanted into a tube that is subjected to centrifugation of 12,500 rpm for 5 minutes to separate the solid phase in suspension from the liquid phases, respectively organic and aqueous.

The organic and aqueous phases obtained at the end of this centrifugation are taken off so as to leave only the solid that has formed in the tube.

This solid is washed by adding 250 μL of ethanol in the tube, triturating using the tip of a pipette, vortex stirring for a few seconds, centrifugation of 12,500 rpm for 5 minutes and removal of the ethanol. The tube is placed in an oven heated at 40° C. for one night to dry the solid.

The solid is then characterised by powder X-ray diffraction by means of a Bruker D8 Advance diffractometer, mounted in accordance with Bragg-Brentano geometry and equipped with a copper source (40 kV, 40 mA, λ=1.5418 Å) and a LynxEye 1D rapid detector.

As for the aqueous and organic phases, their uranium content and, in the case of test 2, their thorium content is (are) determined by inductively coupled plasma atomic emission spectrometry (or ICP-AES).

To do this, the aqueous phase is pipetted and diluted in a matrix solution that is an HNO₃/HCl 2% (90/10, v/v) mixture. The typical dilution is a factor of 1000 obtained by cascade dilution: 50 μL of solution is added to 4.95 mL of matrix solution, and then the solution thus obtained is once again diluted by adding 500 μL of this solution to 4.5 mL of matrix solution.

The organic phase for its part is subjected to stripping by putting in contact with an aqueous solution comprising 0.01 mol/L of HNO₃, in an A/O ratio=10 (i.e. 50 μl of organic phase for 500 μl of aqueous solution), and stirring on orbital shaker (1000 rpm) at 21° C. After settling of the two phases by gravity, a fraction of the aqueous phase is taken off to be diluted from 100 to 1000 times in the HNO₃/HCl 2% (90/10, v/v) matrix solution. The total dilution of the actinides that were initially present in organic phase is therefore by a factor of 1000 to 10,000 during the analysis by ICP-AES.

The wavelengths (nm) used for quantifying the uranium and thorium by ICP-AES are as follows:

| | | | | | |
|---|---|---|---|---|---|
| U: | 279.394 | 367.007 | 385.958 | 409.014; | |
| Th: | | 274.716 | 283.231 | 283.730 | 401.913. |

I.1—Test 1:

This oxalic-precipitation stripping test is implemented using:
an organic solution comprising 0.268 mol/L (i.e. 64 g/L) of uranyl nitrate and 0.325 mol/L of nitric acid, obtained in advance as described above from an aqueous solution comprising 0.326 mol/L (i.e. 77 g/L) of uranyl nitrate and 6 mol/L of nitric acid; and
aqueous solutions all comprising 0.20 mol/L (i.e. 18 g/L) of oxalic acid, one of these solutions being free from nitric acid and the others comprising 0.001 mol/L, 0.01 mol/L, 0.1 mol/L, 1 mol/L or 2 mol/L of nitric acid.

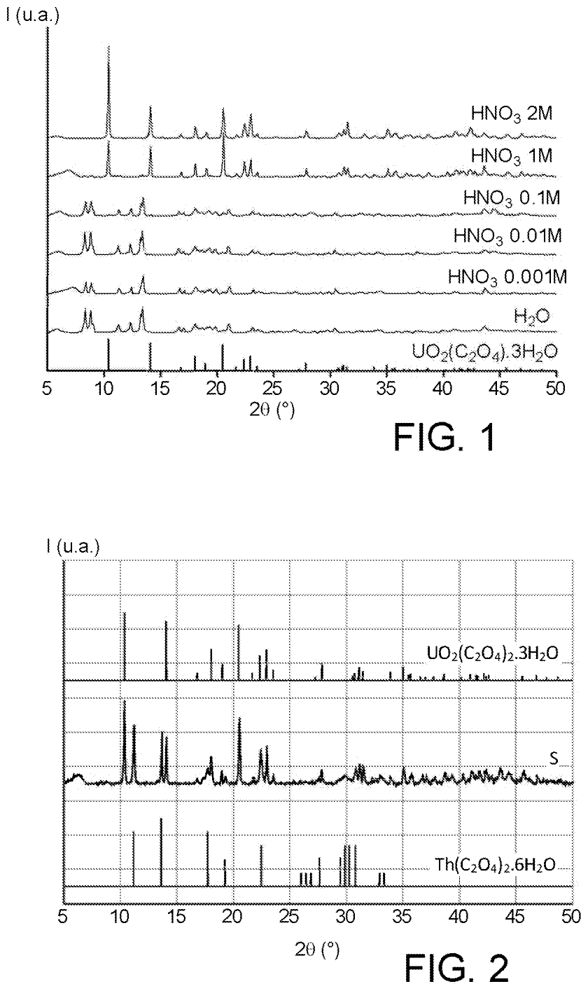

The powder X-ray diffractograms of the solids obtained at the end of this test are presented on FIG. 1, conjointly with the powder X-ray diffractogram of uranyl oxalate trihydrate, UO₂ (C₂O₄)₂·3H₂O serving as a reference.

As this figure shows, for a concentration of nitric acid of less than 1 mol/L, an impurity composed of a mixture of uranium, oxalate and TBP is mainly observed, which is characterised by peaks at 8.3°, 8.8°, 11.2°, 12.4° and 13.4° on the diffractograms. For 1 mol/L of nitric acid, uranyl oxalate is the crystalline compound that is in the great majority while, for 2 mol/L of nitric acid, it is the only crystalline compound detected.

I.2—Test 2:

This oxalic-precipitation stripping test is implemented using:
an organic solution comprising 0.250 mol/L (i.e. 59.5 g/L) of uranyl nitrate, 0.033 mol/L (i.e. 7.5 g/L) of thorium nitrate and 0.352 mol/L of nitric acid, obtained in advance as described above from an aqueous solution comprising 0.326 mol/L (i.e. 77 g/L) of uranyl nitrate, 0.18 mol/L (i.e. 42 g/L) of thorium nitrate and 6 mol/L of nitric acid; and
an aqueous solution comprising 0.24 mol/L (i.e. 22 g/L) of oxalic nitrate and 2 mol/L of nitric acid.

The powder X-ray diffractogram of the solid obtained at the end of this test is presented on FIG. 2, where it is denoted S, conjointly with the powder X-ray diffractograms of uranyl oxalate trihydrate, UO₂ (C₂O₄)₂·3H₂O, and of thorium oxalate hexa hydrate, Th(C₂O₄)₂·6H₂O, serving as references.

As shown by this figure, the only crystalline compounds present in the solid are uranyl oxalate and thorium oxalate.

Moreover, analysis by ICP-AES of the organic and aqueous supernatants does not make it possible to detect thorium in these supernatants, which means that all the thorium is present in the solid.

This analysis also shows that the precipitation yield of uranium is 33% so that the U/Th mass ratio in the solid is 2.5.

II—Outline Diagram of an Embodiment of the Processing Method of the Invention:

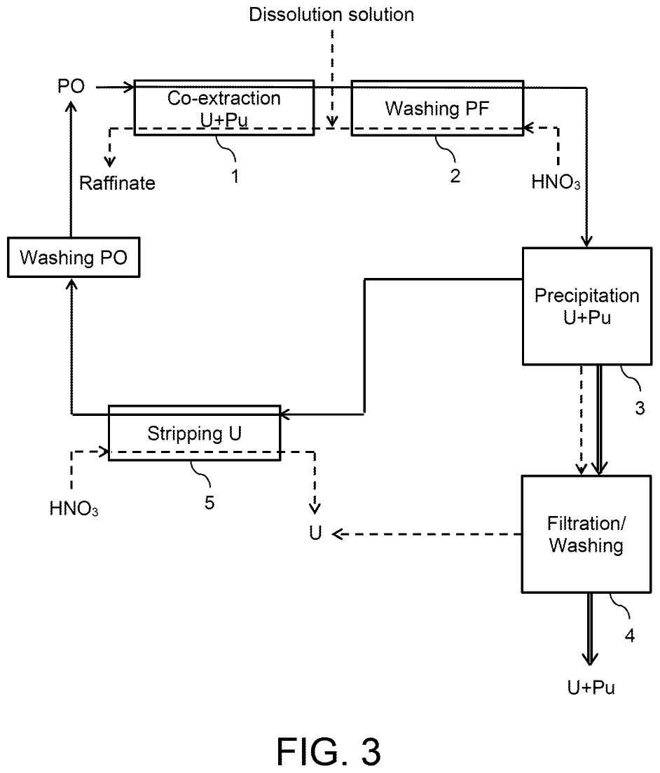

Reference is made to FIG. 3, which shows an outline diagram of an embodiment of the method for processing an aqueous solution issued from a dissolution of a spent nuclear fuel in nitric acid according to the invention.

As shown by this figure, the method comprises 6 steps.

The first of these steps, denoted “Co-extraction U+Pu” on FIG. 3, aims to extract conjointly uranium and plutonium, the first to the degree of oxidation+VI and the second to the degree of oxidation+IV, from the nitric aqueous solution issued from the dissolution of a spent nuclear fuel.

Such a solution typically comprises from 3 mol/L to 6 mol/L of HNO₃, of uranium, plutonium, minor actinides (americium and curium), of fission products (La, Ce, Pr, Nd, Sm, Eu, Gd, Mo, Zr, Ru, Tc, Rh, Pd, Y, Cs, etc) as well as a few corrosion products such as iron.

As is known per se, the “Co-extraction U+Pu” step is implemented by circulating, in the extractor 1, the dissolution solution in counterflow to an organic phase, denoted “PO” on FIG. 3, which comprises TBP, advantageously at a concentration of 30% (v/v), in an organic diluent, for example n-dodecane.

As is also known per se, the second step of the method, denoted “Washing PF” on FIG. 3, aims to strip, from the organic phase resulting from the “Co-extraction U+Pu” step, the fraction of the fission products able to have been extracted from the dissolution solution, conjointly with the uranium and plutonium.

To do this, the organic phase leaving the extractor 1 is circulated, in the extractor 2, in counterflow to a nitric aqueous solution the concentration of which can range from 0.5 mol/L to 6 mol/L of HNO₃ but is preferably from 4 mol/L to 6 mol/L of HNO₃ so as to facilitate the stripping of the ruthenium and technetium.

The third step of the method, denoted “Precipitation” on FIG. 3, aims to strip from the organic phase resulting from the “Washing PF” step all the plutonium present in this phase, conjointly with a fraction of the uranium, by oxalic precipitation.

To do this, the organic phase leaving the extractor 2 is directed to a precipitation unit, denoted 3, where it is put in contact with an aqueous solution comprising 2 mol/L to 6 mol/L of HNO₃ and oxalic acid at a concentration of at least 20 g/L, in an O/A ratio of at least 1 and, preferably, at least 1.5, the concentration of oxalic acid in the aqueous solution and the O/A ratio being selected however so that oxalic acid is deficient (or lacking) with respect to the stoichiometric conditions of a complete precipitation of the uranium and plutonium.

Thus, for example, for an organic phase having a U+Pu content of 72 g/L with a U/Pu mass ratio of the order of 8.2, this organic phase is advantageously put in contact with an aqueous solution comprising 2 mol/L of HNO₃ and 0.24 mol/L (i.e. 22 g/L of oxalic acid in an O/A ratio of 1.

At the end of the “Precipitation” step, three phases are obtained, namely:
a solid phase that contains all the plutonium and a fraction of the uranium that were present in the organic phase resulting from the “Washing PF” step.
an aqueous phase that comprises uranium but is free from plutonium, and
an organic phase that, like the aqueous phase, comprises uranium but is free from plutonium.

By way of example, the use of the operating conditions mentioned above leads to obtaining a solid phase, an aqueous phase and an organic phase that comprise respectively about 33%, 15.60% and 51.40% by mass of the uranium that was present in the organic phase resulting from the “Washing PF” step. The U/Pu mass ratio in the solid phase is 2.7.

The solid and aqueous phases resulting from the “Precipitation” step are directed to a unit, denoted 4 on FIG. 3, assigned to the fourth step of the method, denoted “Filtration/Washing” on this figure, which aims to separate these phases from each other by filtration and to wash the solid phase, preferably in one go, with a nitric aqueous solution comprising no more than 2 mol/L of nitric acid, the washing being followed by a filtration.

In parallel, the organic phase resulting from the “Precipitation” step is directed to the extractor 3 in which the fifth step of the method is implemented, denoted “Stripping U” on FIG. 3, which aims to extract from this organic phase the uranium that it comprises.

To do this, the organic phase leaving the unit 3 is circulated, in the extractor 5, in counterflow to a nitric aqueous solution the HNO₃ concentration of which can range from 0.005 mol/L to 0.05 mol/L.

At the end of these five steps, the following are obtained:
a raffinate that corresponds to the aqueous phase leaving the extractor 1 and comprises fission products as well as americium and curium;
a solid-phase composed of plutonium oxalate and uranium oxalate and which is directed to a workshop dedicated to conversion thereof into a mixed (U,Pu)O₂ oxide, for example by calcination at a temperature ranging from 600° C. to 800° C. under an oxidising atmosphere;
two aqueous phases that correspond to the aqueous phases leaving respectively the unit 4 and extractor 5, which both comprise uranyl nitrate and are directed to a storage unit or to a workshop dedicated to converting this uranyl nitrate into uranium oxide, UO₂, for example by precipitation in the form of uranium peroxide, UO₄, followed by calcination of the precipitate and reduction in hydrogen; and
an organic phase that corresponds to the organic phase leaving the extractor 5, which no longer comprises uranium but which may contain certain impurities and degradation products (formed by hydrolysis and radiolysis) of the TBP that formed during the previous steps.

Thus, the sixth step of the method, denoted “Washing PO” on FIG. 3, aims to regenerate this organic phase by subjecting it to one or more washings with a basic aqueous solution, for example a first washing with an aqueous solution at 0.3 mol/L of sodium carbonate, followed by a second washing with an aqueous solution at 0.1 mol/L of sodium hydroxide, then one or more washings with an aqueous solution of nitric acid enabling it to be reacidified, for example an aqueous solution comprising 2 mol/L of HNO₃, each washing being implemented by circulating said organic phase, in an extractor, in counterflow to the aqueous washing solution.

As can be seen on FIG. 3, the organic phase thus regenerated can then be sent to the extractor 1 for reuse thereof in the processing method.

### REFERENCES CITED

[1] “Treatment and recycling of spent nuclear fuel—Actinide partitioning—Application to waste management”, 2008, Editions Le Moniteur, ISBN 978-2-281-11377-8
[2] WO-A-2007/135178
[3] GB-B-834,531
[4] EP-A-0 251 399

1. A method for stripping uranium(VI) and an actinide(IV) from an organic solution in which the uranium(VI) and the actinide(IV) are present as uranium(VI) nitrate and actinide(IV) nitrate at concentrations such that a uranium(VI) nitrate concentration is higher than an actinide(IV) nitrate concentration, and a sum of the uranium(VI) nitrate concentration and the actinide(IV) nitrate concentration is greater than or equal to 55 g/L, the organic solution comprising tri-n-butyl phosphate in an organic diluent, the method comprising:
contacting the organic solution and an aqueous solution comprising from 2 mol/L to 6 mol/L of nitric acid, and oxalic acid at a concentration greater than or equal to 18 g/L, with an organic solution/aqueous solution volume ratio greater than or equal to 1, wherein the oxalic acid concentration in the aqueous solution and the organic solution/aqueous solution volume ratio is selected so that the oxalic acid is deficient with respect to the stoichiometric conditions of a complete precipitation of uranium(VI) and actinide(IV), to obtain a precipitate comprising the actinide(IV) in oxalate form and a fraction of the uranium(VI) in oxalate form with a U(VI)/actinide(IV) mass ratio of between 0.5 and 5; and
separating the precipitate from the organic solution and aqueous solution.

2. The method of claim 1, wherein the organic solution comprises from 25% to 35% (v/v) of tri-n-butyl phosphate.

3. The method of claim 2, wherein the organic solution comprises 30% (v/v) of tri-n-butyl phosphate.

4. The method of claim 1, wherein the oxalic acid concentration in the aqueous solution is greater than or equal to 20 g/L.

5. The method of claim 4, wherein the oxalic acid concentration in the aqueous solution is greater than or equal to 22 g/L.

6. The method of claim 1, wherein the organic solution/aqueous solution volume ratio is greater than or equal to 1.5.

7. The method of claim 1, further comprising one or more washings of the precipitate with an aqueous solution comprising nitric acid, each washing being followed by a separation of the precipitate from the washing aqueous solution.

8. The method of claim 1, further comprising one or more washings of the precipitate with an organic solution comprising the organic diluent, each washing being followed by a separation of the precipitate from the washing organic solution.

9. The method of claim 1, wherein the actinide(IV) is plutonium(IV) or thorium(IV).

10. The method of claim 9, wherein the actinide(IV) is plutonium(IV).

11. A method for processing an aqueous solution issued from a dissolution of a spent nuclear fuel in nitric acid, the aqueous solution A1 comprising at least uranium(VI) and an actinide(IV), the method comprising at least the steps of:
a) co-extracting the uranium(VI) and actinide(IV) from the aqueous solution A1, the co-extracting comprising at least one contact between the aqueous solution A1 and an organic solution comprising tri-n-butyl phosphate in an organic diluent, and then separating the aqueous solution from the organic solution, whereby the uranium(VI) and the actinide(IV) are present in the organic solution issued from step a) as uranium(VI) nitrate and actinide(IV) nitrate at concentrations such that a uranium(VI) nitrate concentration is higher than an actinide(IV) nitrate concentration, and a sum of the uranium(VI) nitrate concentration and the actinide(IV) nitrate concentration is greater than or equal to 55 g/L;
b) stripping the actinide(IV) and a fraction of the uranium(VI) from the organic solution issued from step a), the stripping comprising:
at least one contact between the organic solution issued from step a) and an aqueous solution A2 comprising from 2 mol/L to 6 mol/L of nitric acid, and oxalic acid at a concentration greater than or equal to 18 g/L, with an organic solution/aqueous solution A2 volume ratio greater than or equal to 1, the oxalic acid concentration in the aqueous solution A2 and the organic solution/aqueous solution A2 volume ratio being selected so that the oxalic acid is deficient with respect to the stoichiometric conditions of a complete precipitation of uranium(VI) and actinide(IV), whereby a precipitate is obtained comprising the actinide(IV) in oxalate form and a fraction of the uranium(VI) in oxalate form with a U(VI)/actinide(IV) mass ratio of between 0.5 and 5; then
a separation of the precipitate from the organic solution and aqueous solution A2; and
c) stripping from the organic solution issued from step b) the uranium(VI) that was not stripped in step b), the stripping comprising at least one contact between the organic solution issued from step b) and an aqueous solution A3 comprising from 0.005 mol/L to 0.05 mol/L of nitric acid, and then a separation of the organic solution from the aqueous solution A3.

12. The method of claim 11, wherein the organic solution comprises from 25% to 35% (v/v) of tri-n-butyl phosphate.

13. The method of claim 11, wherein the oxalic acid concentration in the aqueous solution A1 is greater than or equal to 20 g/L.

14. The method of claim 13, wherein the oxalic acid concentration in the aqueous solution A1 is greater than or equal to 22 g/L.

15. The method of claim 11, wherein the organic solution/aqueous solution A1 volume ratio is greater than or equal to 1.5.

16. The method of claim 11, further comprising, between steps a) and b), a washing of the organic solution issued from step a), the washing comprising at least one contact between the organic solution issued from step a) and an aqueous solution A4 comprising from 0.5 mol/L to 6 mol/L of nitric acid, and then a separation of the organic solution from the aqueous solution A4.

17. The method of claim 16, wherein the aqueous solution A4 comprises from 4 mol/L to 6 mol/L of nitric acid.

18. The method of claim 11, further comprising a regeneration of the organic solution issued from step c) for reuse thereof in step a).

19. The method of claim 11, further comprising a conversion of the precipitate issued from step b) into a mixed uranium(VI) and actinide(IV) oxide.

20. The method of claim 11, wherein the actinide(IV) is plutonium(IV) or thorium(IV).
